(19) United States
(12) Patent Application Publication
(10) Pub. No.: US 2008/0144506 A1
(43) Pub. Date: Jun. 19, 2008

(54) CONTROL APPARATUS, CONTROL METHOD, COMMUNICATION SYSTEM COMPRISING CONTROL APPARATUS AND ONE OR MORE TERMINALS

(75) Inventor: Tetsuo Kanda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/952,762

(22) Filed: Dec. 7, 2007

(30) Foreign Application Priority Data
Dec. 19, 2006 (JP) 2006-341129

(51) Int. Cl. G08C 15/00

(52) U.S. Cl. 370/235

(57) ABSTRACT

In a radio communication system including terminals that access a control apparatus by a random access method, the number of collisions between data transmitted from the terminals is reduced. A control method for the control apparatus capable of communicating with at least one terminal located within a communicable range includes transmitting information designating a communication period in which the terminal transmits data to the control apparatus, changing a transmission range over which the information is transmitted, and transmitting, after transmitting first information designating a first communication period over a first transmission range, second information designating a second communication period which differs from the first communication period over a changed second transmission range.

### BACKGROUND OF THE INVENTION

1. Field of the Invention

The present invention relates to a control apparatus, a control method, and a communication system comprising a control apparatus and one or more terminals that are each adapted for data communication utilizing a communication function. More particularly, the present invention relates to a communication system in which each terminal has a function of accessing a control apparatus by a random access method.

2. Description of the Related Art

Hitherto, in a random access method for communication between terminals and a control apparatus, individual terminals transmit data to the control apparatus at random, resulting in a collision may occur between data transmitted from the terminals.

Japanese Patent Laid-Open No. 2003-348636 discloses a technique for addressing the above-described situation.

With the technique disclosed in Japanese Patent Laid-Open No. 2003-348636, even when a terminal performing communication by the random access method produces data to be transmitted, it does not try to transmit the data at once but tries to transmit the data after the lapse of a certain standby time. With such a feature, when a particular terminal continuously performs data transmission, the disclosed technique can prevent the communication between one or more other terminals and the control apparatus from being lost due to biasing in acquisition of communication right to the particular terminal.

However, when the number of terminals communicating with the control apparatus is increased, it is difficult to suppress the generation of collisions between data transmitted from the terminals.

In addition, because each terminal executes the same control regardless of the number of the terminals communicating with the control apparatus, communication efficiency in an entire system is reduced when the number of the terminals communicating with the control apparatus is small.

### SUMMARY OF THE INVENTION

The present invention is directed to a communication system in which each terminal has a function of accessing a control apparatus by a random access method.

According to one aspect of the present invention, a control apparatus capable of communicating with a terminal includes a transmitting unit configured to transmit information designating a communication period in which the terminal transmits data to the control apparatus, a changing unit configured to change a transmission range over which the information is transmitted, and a control unit configured to transmit, after transmitting first information designating a first communication period over a first transmission range, second information designating a second communication period which differs from the first communication period over a second transmission range changed by the changing unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a block diagram of a control apparatus according to a first exemplary embodiment of the present invention.

FIG. 2 is a block diagram of a terminal according to the first exemplary embodiment of the present invention.

FIG. 3 is a flowchart of the control apparatus according to the first exemplary embodiment of the present invention.

FIG. 4 is a flowchart of the terminal in the first exemplary embodiment of the present invention.

FIG. 5 illustrates a model of a radio (wireless) communication system according to the first exemplary embodiment of the present invention.

FIG. 6 is a timing chart in the first exemplary embodiment of the present invention.

FIG. 7 is an operation flowchart in the first exemplary embodiment of the present invention.

FIG. 8 illustrates a registration management table in a second exemplary embodiment of the present invention.

FIGS. 9A and 9B are each a flowchart of a control apparatus according to the second exemplary embodiment of the present invention.

FIG. 10 illustrates a model of a radio (wireless) communication system in the second exemplary embodiment of the present invention.

FIGS. 11A-11C are each a timing chart in the second exemplary embodiment of the present invention.

FIGS. 12A-12C are each an operation flowchart in the second exemplary embodiment of the present invention.

FIGS. 13A and 13B are each a flowchart of a control apparatus according to a third exemplary embodiment of the present invention.

FIGS. 14A-14C each illustrate a model of a radio (wireless) communication system in the third exemplary embodiment of the present invention.

FIGS. 15A and 15B are each a timing chart in the third exemplary embodiment of the present invention.

FIGS. 16A and 16B are each an operation flowchart in the third exemplary embodiment of the present invention.

### DESCRIPTION OF THE EMBODIMENTS

Exemplary embodiments of the present invention will be described, only by way of illustrative purposes, below with reference to the drawings.

A first exemplary embodiment is described in connection with a case where a terminal 20 transmits data to a control apparatus 10 by using a Slotted-ALOHA method that is one of random access methods.

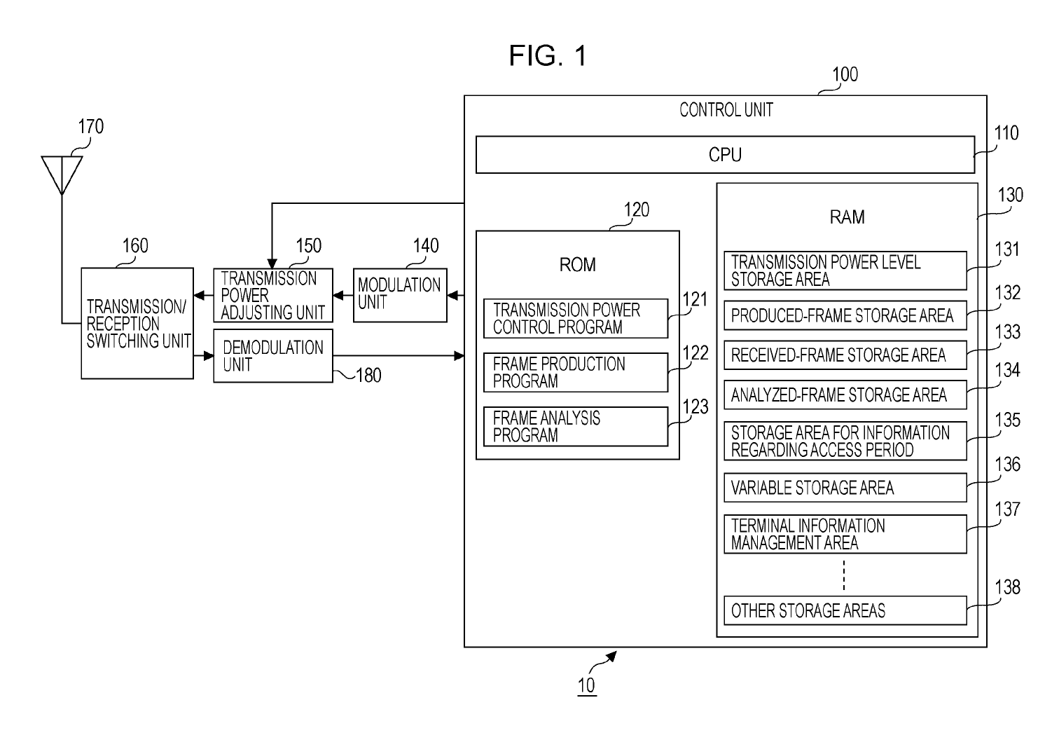

FIG. 1 is a block diagram of the control apparatus 10 according to the first exemplary embodiment of the present invention.

A control unit 100 includes a CPU 110, a ROM 120, and a RAM 130.

The CPU 110 is operated in accordance with various programs stored in the ROM 120. For example, in accordance with a transmission power control program 121 stored in the ROM 120, the CPU 110 outputs an instruction to a transmission power adjusting unit 150 to control transmission power.

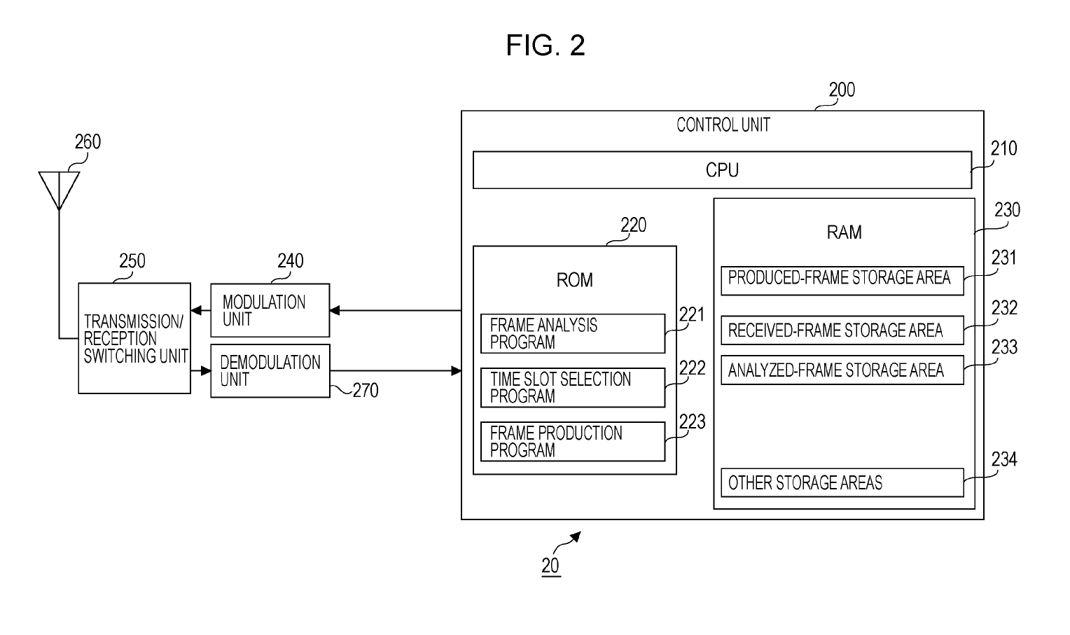

In addition, in accordance with a frame production program 122 stored in the ROM 120, the CPU 110 produces a frame and stores it in a produced-frame storage area 132. When producing the frame, the CPU 110 causes the frame to hold information regarding an access period during which the terminal 20 (see FIG. 2) accesses the control apparatus 10, e.g., a start time and an end time of the access period, and the number N of time slots (N is an arbitrary natural number) included in the access period. The information designated herein is stored in a storage area 135 for the information regarding the access period to be used later. Then, the CPU 110 sends the produced frame to a modulation unit 140 for transmission of the frame.

Further, in accordance with a frame analysis program 123, the CPU 110 analyzes the frame received from the terminal 20. The analyzed frame is stored in an analyzed-frame storage area 134. Processing executed by the CPU 110 in accordance with the programs in the ROM 120 is not limited to the above-described examples, and the CPU 110 executes other various kinds of processing required for the control apparatus 10 to execute necessary control.

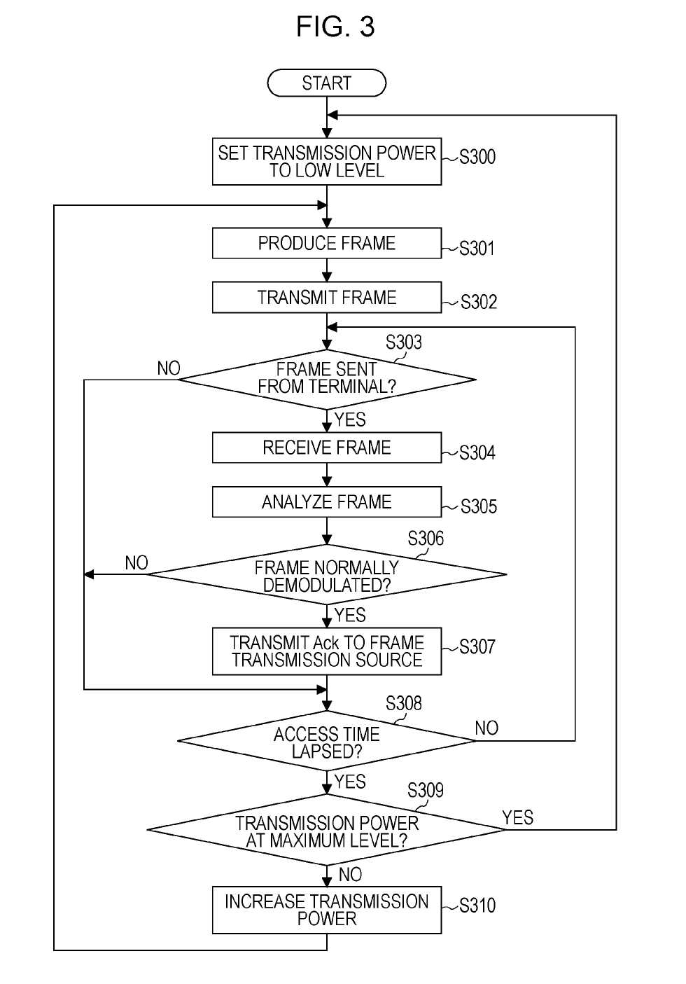

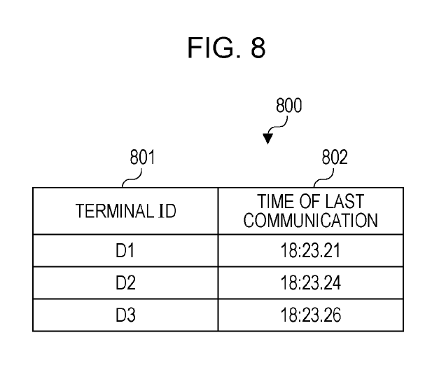

In addition to the above-described programs, the ROM 120 stores programs corresponding to flowcharts of FIGS. 3 and 8 and other various programs. Those programs are also executed by the CPU 110.

The RAM 130 has a work area that is used when the CPU 110 executes the programs. In addition, the RAM 130 has areas storing various kinds of data illustrated in FIG. 1. Examples of those areas include the transmission power level storage area 131, the produced-frame storage area 132, the received-frame storage area 133, the analyzed-frame storage area 134, and the storage area 135 for the information regarding the access period. Further, the RAM 130 has a storage area 136 for variables used in the control, a terminal information management area 137, and other storage areas 138.

The modulation unit 140 modulates the frame sent from the control unit 100 and transfers the modulated frame to the transmission power adjusting unit 150.

The transmission power adjusting unit 150 adjusts power for transmitting the frame, which is sent from the modulation unit 140, based on the transmission power that is decided in accordance with the instruction from the CPU 110, and transfers the modulated transmission power to a transmission/reception switching unit 160. Thereafter, the frame sent to the transmission/reception switching unit 160 is transmitted through an antenna 170. The transmission power adjusting unit 150 can increase or decrease a transmission power level in a stepwise or continuous manner between a minimum transmission power level and a maximum transmission power level. The term “maximum transmission power level” used herein means a level set in conformity with a limitation in terms of hardware or any type of non-hardware restriction, such as limitation stipulated by the government.

The demodulation unit 180 demodulates a frame received from the exterior through the antenna 170 and the transmission/reception switching unit 160.

An overall configuration of the terminal 20 will be described next.

FIG. 2 is a block diagram illustrating the overall configuration of the terminal 20 according to the present embodiment.

A control unit 200 includes a CPU 210, a ROM 220, and a RAM 230.

The CPU 210 stores the frame, which has been received from the control apparatus 10, in a received-frame storage area 232, and then analyzes the received frame in accordance with a frame analysis program 221 stored in the ROM 220. The analyzed frame is stored in an analyzed-frame storage area 233.

Further, based on the information such as the start time of the access period and the number N of time slots that are obtained by the analysis of the frame, the CPU 210 executes a process of selecting a time slot when the frame is transmitted, in accordance with a time slot selection program 222.

Moreover, the CPU 210 executes a process of producing a frame in accordance with a frame production program 223. More specifically, the CPU 210 temporarily stores the produced frame in a produced-frame storage area 231 and then sends the produced frame to a modulation unit 240 when it is transmitted. The processes executed by the CPU 210 in accordance with the programs in the ROM 220 are not limited to the above-described ones, and the CPU 210 further executes various processes required for control of the terminal 20.

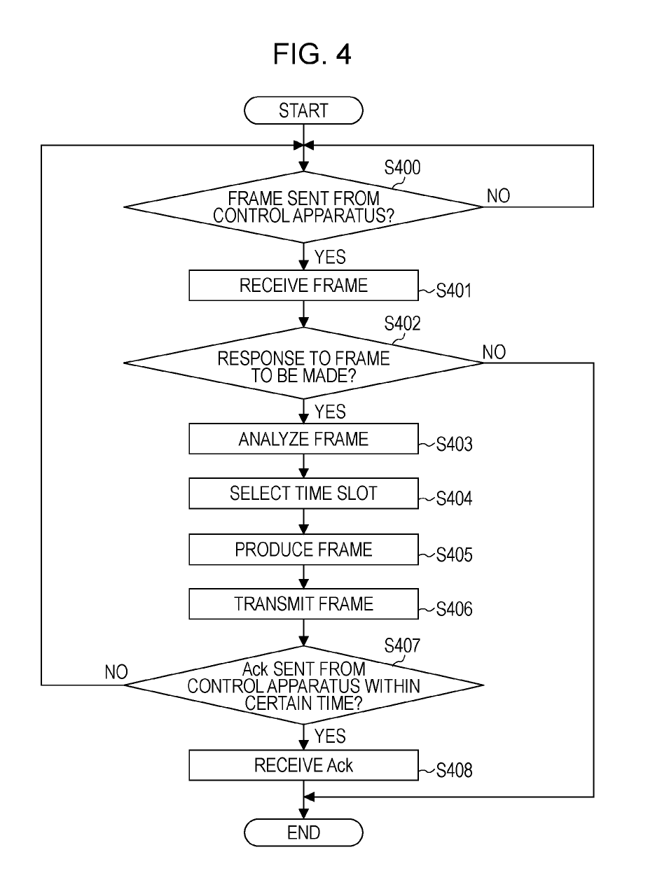

In addition to the above-described programs, the ROM 220 stores a programs corresponding to a flowchart of FIG. 4 and other various programs. Those programs are also executed by the CPU 210.

The RAM 230 has a work area that is used when the CPU 210 executes the programs. In addition, the RAM 230 has areas for storing various kinds of data illustrated in FIG. 2. Examples of those areas include the produced-frame storage area 231, the received-frame storage area 232, the analyzed-frame storage area 233, and other storage areas 234.

The modulation unit 240 modulates the frame sent from the control unit 200. The modulated frame is transmitted through a transmission/reception switching unit 250 and an antenna 260. A demodulation unit 270 demodulates a frame received through the antenna 260 and the transmission/reception switching unit 250, and transfers the demodulated frame to the control unit 200.

Next, the operation of the control apparatus 10 according to the present embodiment will be described with reference to a flowchart of FIG. 3.

First, the CPU 110 of the control apparatus 10, issues an instruction to the transmission power adjusting unit 150 in accordance with the transmission power control program 121, thereby setting the transmission power to a low level (step S300). At that time, the CPU 110 stores, in the transmission power level storage area 131 of the RAM 130, the fact that the transmission power is set to the low level.

Then, the CPU 110 produces a frame holding the information regarding the access period (hereinafter referred to as a “broadcast frame”) in accordance with the frame production program 122, and stores the produced frame in the produced-frame storage area 132 of the RAM 130 (step S301). At that time, the CPU 110 stores, in the storage area 135 for the information regarding the access period, the information which has been designated as the information regarding the access period, e.g., the start time and the end time of the access period, and the number N of time slots (N is an arbitrary natural number) included in the access period.

Then, the CPU 110 transmits (in step S302) the broadcast frame, produced in step S301, with the transmission power at the low level that has been set in step S300.

Thereafter, if a frame is sent from the terminal 20 (the frame sent from the terminal 20 to the control apparatus 10 is called the “radio frame” herein) in response to the transmitted broadcast frame, the CPU 110 receives the radio frame and stores the received radio frame in the received-frame storage area 133 (steps S303-S304). The CPU 110 analyzes the received radio frame and stores the analyzed radio frame in the analyzed-frame storage area 134 of the RAM 130 (step S305). On the other hand, if no radio frame is received in step S303, the process proceeds to step S308.

In step S306, the CPU 110 determines, based on the analysis result of the radio frame, whether the received radio frame is normally demodulated by the demodulation unit 180. If the determination result indicates that the received radio frame is normally demodulated, the CPU 110 transmits, in step S307, a signal indicating that the frame has been normally received, i.e., a reception acknowledgement signal (Ack), to the terminal 20 that is a transmission source of the relevant frame. For example, if the radio frames transmitted from the plural terminals 20 collide with each other, those frames cannot be normally demodulated and the CPU 110 determines in step S306 that the frames are not normally demodulated. Therefore, the CPU 110 does not transmit the Ack to the terminal 20 in step S307 and proceeds to step S308.

In step S308, the CPU 110 refers to the information that has been stored in the storage area 135 for the information regarding the access period at the time of producing the broadcast frame, and determines whether the access period has lapsed. If the determination result indicates that the access period is not yet lapsed, the process returns to step S303.

On the other hand, if the determination results in step S308 indicates that the access period has lapsed, the process proceeds to step S309 and where the CPU 110 determines whether the set transmission power is at a maximum level, by referring to the transmission power level stored in the transmission power level storage area 131. Since the transmission power now remains at the low level set in step S300, the CPU 110 determines that the transmission power level is not at the maximum level, and the process proceeds to step S310. In step S310, the CPU 110 increases the transmission power of the transmission power adjusting unit 150 in accordance with the transmission power control program 121, and the process returns to step S301. When the CPU 110 increases the transmission power, the value of the transmission power level stored in the transmission power level storage area 131 is updated to a value resulting after the transmission power has been increased.

Then, the CPU 110 repeats the processing of steps S301-S310. However, if the transmission power is determined in step S309 to be at the maximum level as a result of increasing the transmission power in step S310 several times, the process returns to step S300 and the transmission power is set to the low level. At that time, the CPU 110 stores, in the transmission power level storage area 131 of the RAM 130, the fact that the transmission power is set to the low level.

The operation of the terminal 20 will be described next.

The terminal 20 receives the broadcast frame sent from the control apparatus 10 and transmits the radio frame to the control apparatus 10. However, the terminal 20 does not respond to all of the broadcast frames received from the control apparatus 10. Once the communication with the control apparatus 10 is completed, the terminal 20 determines that the communication is not needed for a subsequent certain period even when the broadcast frame is sent. Based on such determination, the terminal 20 does not respond to the broadcast frame for that certain period. Such a feature enables the terminal 20, which has not yet succeeded in communicating with the control apparatus 10, to perform the communication with priority.

The operation of the terminal 20 according to the present embodiment will now be described with reference to a flowchart of FIG. 4.

First, if the broadcast frame is sent from the control apparatus 10 in step S400, the process proceeds to step S401, where the CPI 210 receives the broadcast frame and stores the received broadcast frame in the received-frame storage area 232.

Then, the CPU 210 determines in step S402 whether a response to the received broadcast frame is to be made. If the CPU 210 determines that the response is not to be made, the processing ends. Such determination is made, for example, when the terminal 20 having succeeded in communicating with the control apparatus 10 upon receiving the Ack from the control apparatus 10 starts to count a certain period after the time at which the communication has succeeded and then determines that the certain period is not yet lapsed.

If the CPU 210 determines that the response is to be made, the process proceeds to step S403. In step S403, the CPU 210 analyzes the broadcast frame, which has been stored in the received-frame storage area 232 in accordance with the frame analysis program 22, and stores the analyzed frame in the analyzed-frame storage area 233. Then, the CPU 210 recognizes, from the analyzed frame, the information regarding the access period (e.g., the start time and the end time of the access period) and the number N of time slots included in the access period, which has been designated by the control apparatus 10.

In step S404, the CPU 210 selects one of the recognized N time slots at an even-probability in accordance with the time slot selection program 222. Then, in step S405, the CPU 210 produces the radio frame (including a radio frame for requesting connection to the control apparatus 10, called a “connection request frame”, which is described below) in accordance with the frame production program 223. After the CPU 210 stores the produced radio frame in the produced-frame storage area 231, the process proceeds to step S406. In step S406, the CPU 210 transmits the produced radio frame to the control apparatus 10 in the time slot selected in step S404.

Thereafter, in step S407, the CPU 210 waits for a reception acknowledgement signal (Ack) sent from the control apparatus 10 to recognize that the transmitted radio frame has been normally received by the control apparatus 10. If the Ack is sent within a certain period, the process proceeds to step S408. By receiving the sent Ack, the CPU 210 recognizes that the transmitted radio frame has been normally received by the control apparatus 10, and then the processing ends. On the other hand, if the Ack is not sent within the certain period in step S407, the CPU 210 transmits the radio frame again. In that case, the process returns to step S400 and waits again for the broadcast frame sent from the control apparatus 10.

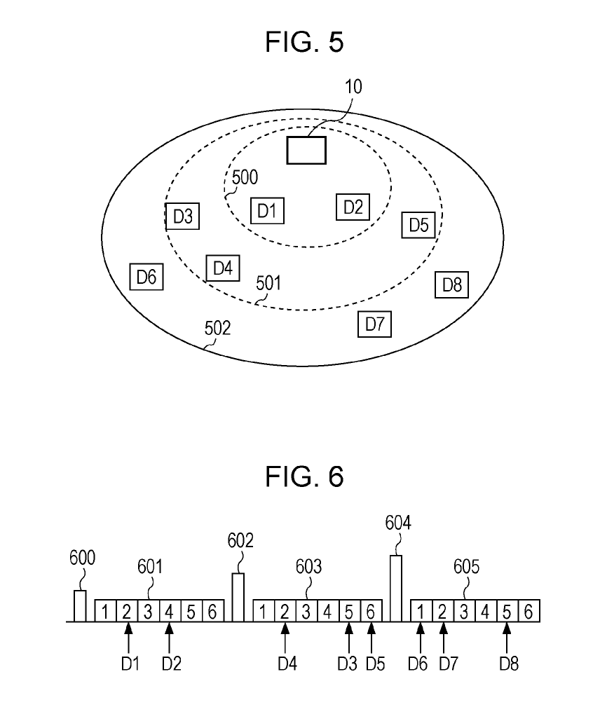

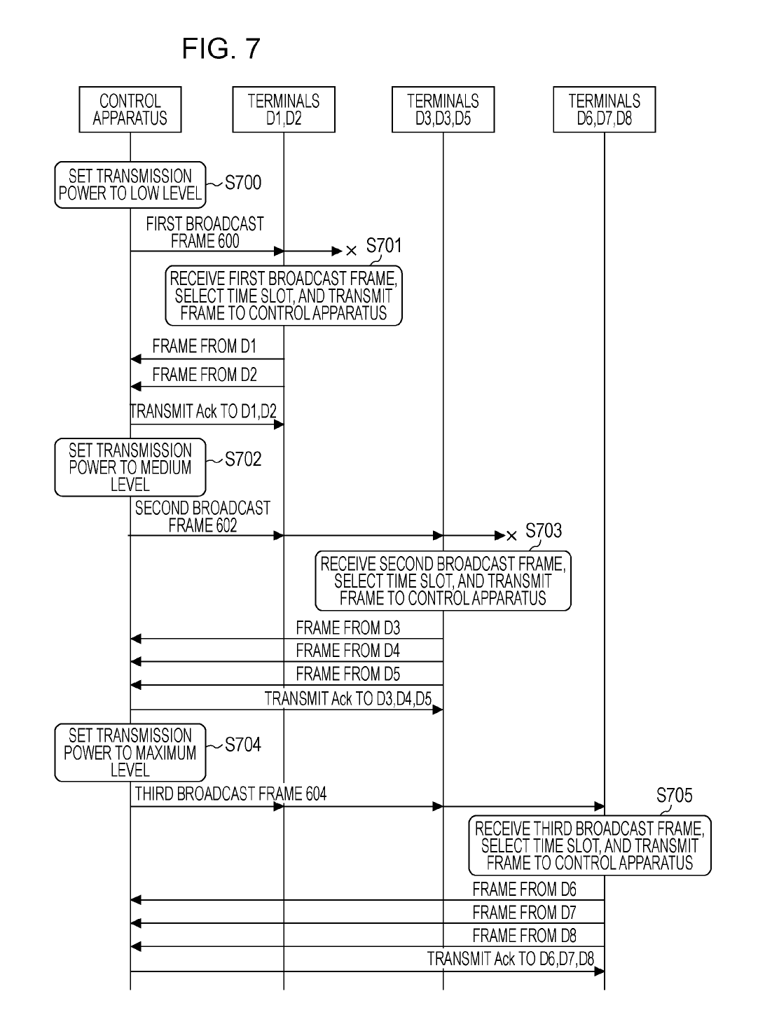

An example of the operation of the above-described system including the control apparatus 10 and the terminal 20 is described below with reference to a system illustration of FIG. 5, a timing chart of FIG. 6, and an operation flowchart of FIG. 7.

It is presumed, as illustrated in FIG. 5, that the radio communication system includes one control apparatus 10 and eight terminals 20 (D1-D8), and that the control apparatus 10 activates a series of sequences which are started by transmitting three broadcast frames. The three broadcast frames are transmitted with transmission power in three stages, i.e., a low level, a medium level, and a maximum level. A frame reachable range varies depending on the magnitude of the transmission power to transmit the frame. As the transmission power increases, the frame can reach up to a range farther away from the control apparatus 10.

In the present embodiment, the range up to which the broadcast frame transmitted with the transmission power at the low level can reach is represented by a first broadcast frame reachable range 500. Similarly, the range up to which the broadcast frame transmitted with the transmission power at the medium level can reach is represented by a second broadcast frame reachable range 501, and the range up to which the broadcast frame transmitted with the transmission power at the maximum level can reach is represented by a third broadcast frame reachable range 502.

FIG. 6 illustrates timings at which the terminals D1-D8 make accesses in first to third access periods 601, 603 and 605 designated respectively by a first broadcast frame 600, a second broadcast frame 602, and a third broadcast frame 604 that are transmitted from the control apparatus 10. Each access period is divided into six time slots. Because each terminal 20 responding to the broadcast frame is operated according to the Slotted-ALOHA method, the terminal 20 selects one of the six time slots and transmits a radio frame in the selected time slot.

The operations of the control apparatus 10 and the terminals 20 (D1-D8) are now described with reference to an operation flowchart of FIG. 7. As illustrated in FIG. 7, the control apparatus 10 starts processing by activating a series of sequences to transmit three successive broadcast frames while changing the transmission power level.

First, in step S700, the CPU 110 of the control apparatus 10 transmits the first broadcast frame 600 with the transmission power at the low level. The first broadcast frame 600 reaches up to the first broadcast frame reachable range 500. Therefore, among the plural terminals D1-D8, only the terminals located within the first broadcast frame reachable range 500 can receive the first broadcast frame 600. In the illustrated example, only the terminals D1 and D2 located within the first broadcast frame reachable range 500 can receive the first broadcast frame 600, while the other terminals D3-D8 cannot receive the first broadcast frame 600.

In step S701, each of the terminals D1 and D2 having received the first broadcast frame 600 recognizes the first access period 601 based on the information regarding the access period, which is included in the first broadcast frame 600. Further, based on the information of time slots, each of the terminals D1 and D2 selects one of the time slots in which an access is to be made. Thereafter, the terminals D1 and D2 transmit radio frames to the control apparatus 10 in the respective selected time slots.

Such a behavior is illustrated in FIG. 6. In the illustrated example, D1 transmits the radio frame in the second time slot within the first access period 601, and D2 transmits the radio frame in the fourth time slot. Therefore, the radio frames transmitted from the respective terminals 20 (D1 and D2) are normally received by the control apparatus 10 without causing a frame collision. Stated another way, the terminals recognizing the presence of the first access period 601 subsequent to the first broadcast frame 600 are limited to only D1 and D2. Accordingly, the terminals competitively accessing a radio channel in the first access period 601 are only D1 and D2. Thus, the number of the accessing terminals is limited and the probability of causing the frame collision is reduced.

The control apparatus 10 having normally received the radio frames sent from the terminals D1 and D2 transmits the Ack to the terminals D1 and D2. The terminals D1 and D2 having received the Ack recognize that the communication with the control apparatus 10 has succeeded.

The terminals D1 and D2 having received the Ack make no responses for a subsequent certain period even when they receive the broadcast frame from the control apparatus 10.

Next, in step S702, the CPU 110 of the control apparatus 10 sets the transmission power to the medium level and transmits the second broadcast frame 602 with the medium transmission power. The second broadcast frame 602 reaches up to the second broadcast frame reachable range 501 illustrated in FIG. 5. The terminals located within the second broadcast frame reachable range 501 are D1-D5. However, because D1 and D2 have already completed the communication with the control apparatus 10 in the first access period 601 subsequent to the first broadcast frame 600, they are no longer required to respond to the second broadcast frame 602 and to access the control apparatus 10. Such a feature is based on the control that the terminals D1 and D2 having confirmed the success of communication with the control apparatus 10 make no responses for the subsequent certain period even when they receive the broadcast frame from the control apparatus 10. Accordingly, three terminals D3-D5 access the control apparatus 10 in the second access period 603 arranged subsequent to the second broadcast frame 602.

In step S703, each of the terminals D3, D4 and D5 accessing the control apparatus 10 recognize the second access period 601 based on the information regarding the access period, which is included in the second broadcast frame 602. Further, based on the information of time slots, each of the terminals D3, D4 and D5 selects one of the time slots in which an access is to be made. Thereafter, the terminals D3, D4 and D5 transmit radio frames to the control apparatus 10 in the respective selected time slots.

In FIG. 6, in response to the second broadcast frame 602, D4 transmits the radio frame in the second time slot within the second access period 603, D3 transmits the radio frame in the fifth time slot, and D5 transmits the radio frame in the sixth time slot. Therefore, the radio frames transmitted from the respective terminals 20 (D3-D5) are normally received by the control apparatus 10 without causing a frame collision. Thus, the number of the terminals 20 accessing the control apparatus 10 in response to the second broadcast frame 602, which has been transmitted with the transmission power at the medium level, is limited to three. As a result, the probability of causing the frame collision is reduced.

The control apparatus 10 having normally received the radio frames sent from the terminals D3, D4 and D5 transmits the Ack to the terminals D3, D4 and D5. The terminals D3, D4 and D5 having received the Ack recognize that the communication with the control apparatus 10 has succeeded, and make no responses for a subsequent certain period even when they receive the broadcast frame from the control apparatus 10.

Finally, in step S704, the CPU 110 of the control apparatus 10 transmits the third broadcast frame 604 with the transmission power at the maximum level. The third broadcast frame 604 is transmitted with the maximum transmission power and reaches up to the third broadcast frame reachable range 502 illustrated in FIG. 5. The third broadcast frame 604 is received by all the terminals 20. However, because the terminals D1-D5 have already completed the communication with the control apparatus 10 in the first access period 601 and the second access period 603, they do no respond to the third broadcast frame 604. Such a feature is based on the control that the terminals D1-D5 having confirmed the success of communication with the control apparatus 10 make no responses for the subsequent certain period even when they receive the broadcast frame from the control apparatus 10. Accordingly, three terminals D6-D8 access the control apparatus 10 in the third access period 605 arranged subsequent to the third broadcast frame 604.

In step S705, each of the terminals D6, D7 and D8 having received the third broadcast frame 604 recognizes the third access period 605 based on the information regarding the access period, which is included in the third broadcast frame 604. Further, based on the information of time slots, each of the terminals D6, D7 and D8 selects one of the time slots in which an access is to be made. Thereafter, the terminals D6, D7 and D8 transmit radio frames to the control apparatus 10 in the respective selected time slots.

In FIG. 6, D6 accesses the radio channel in the first one of the time slots within the third access period 605, D7 accesses the radio channel in the second time slot, and D8 accesses the radio channel in the sixth time slot. Therefore, the radio frames transmitted from the respective terminals 20 (D6-D8) are normally received by the control apparatus 10 without causing a frame collision. The control apparatus 10 having normally received the radio frames sent from the terminals D6, D7 and D8 transmits the Ack to the terminals D6, D7 and D8.

As described above, by gradually increasing the transmission power of the three broadcast frames transmitted from the control apparatus 10, the number of the terminals responding to each of the three broadcast frames can be limited and the frame collision caused by the competitive accesses can be reduced.

Note that the terminal 20 in the present embodiment is not limited to information equipment such as a cellular phone or a computer, and any other devices including a communication function can be used as the terminal 20. The control apparatus 10, in addition to being a radio access point that performs communication control for the terminal 20, can also be information equipment such as a cellular phone and a computer.

A second exemplary embodiment of the present invention will now be described.

The configuration of a control apparatus according to the second exemplary embodiment is described by referring to FIG. 1.

In a radio communication system such as a WPAN system, a terminal 20 having newly started up the operation participates in the service area of a control apparatus 10 as the occasion requires. At that time, the terminal 20 transmits a connection request frame, which includes information regarding the terminal 20, to the control apparatus 10 by using the Slotted-ALOHA method.

When the control apparatus 10 normally receives the connection request frame without a collision, the control apparatus 10 recognizes the presence of the new terminal 20 within its own service area. Further, the control apparatus 10 confirms the terminal 20, which is located within the service area, by registering information regarding the terminal 20 in the terminal information management area 137 of the RAM.

FIG. 8 illustrates an example of the format of the registered information. In FIG. 8, reference number 800 denotes a registration management table. Reference number 801 denotes a terminal ID column of the registration management table 800 containing the terminal ID of the terminal 20 registered in the control apparatus 10. The terminal ID can be obtained from a result of analyzing the connection request frame transmitted from the terminal 20 and it is used to uniquely identify each terminal. Reference number 802 denotes a time of last communication column in the registration management table 800 where the time at which the control apparatus 10 last communicated with each terminal 20 is registered.

When the CPU 110 of the control apparatus 10 normally receives the connection request frame, it analyzes the received frame and reads, from the analysis result, information regarding the terminal 20 that is a transmission source of the received frame. The CPU 110 registers, in the terminal ID column 801, the terminal ID obtained from the analysis result and also registers, in the time of last communication column 802, the time obtained by analyzing the relevant frame. Thereafter, when it is confirmed as a result of analyzing the received frame that the transmission source of the received frame is one of the terminals 20 having been already registered in the registration management table 800, the CPU 110 of the control apparatus 10 updates the time in the time of last communication column 802 at which it last communicated with the relevant terminal 20.

Further, the CPU 110 of the control apparatus 10 deletes the registration of the terminal 20 which has not performed communication in spite of the lapse of a preset time from the time registered in the time of last communication column 802 at which the control apparatus 10 last communicated with the relevant terminal 20. In such a way, the control apparatus 10 executes the registration and the deletion of each terminal 20.

In addition, the CPU 110 prepares a variable L in the variable storage area 136, counts the number of the terminals 20 registered in the registration management table 800, and stores the counted value. Each time the terminal 20 is registered or deleted, the CPU 110 updates the stored value to a value resulting after the registration or the deletion. With the above-described processing, the CPU 110 confirms the number of the terminals 20 that are in the connected state.

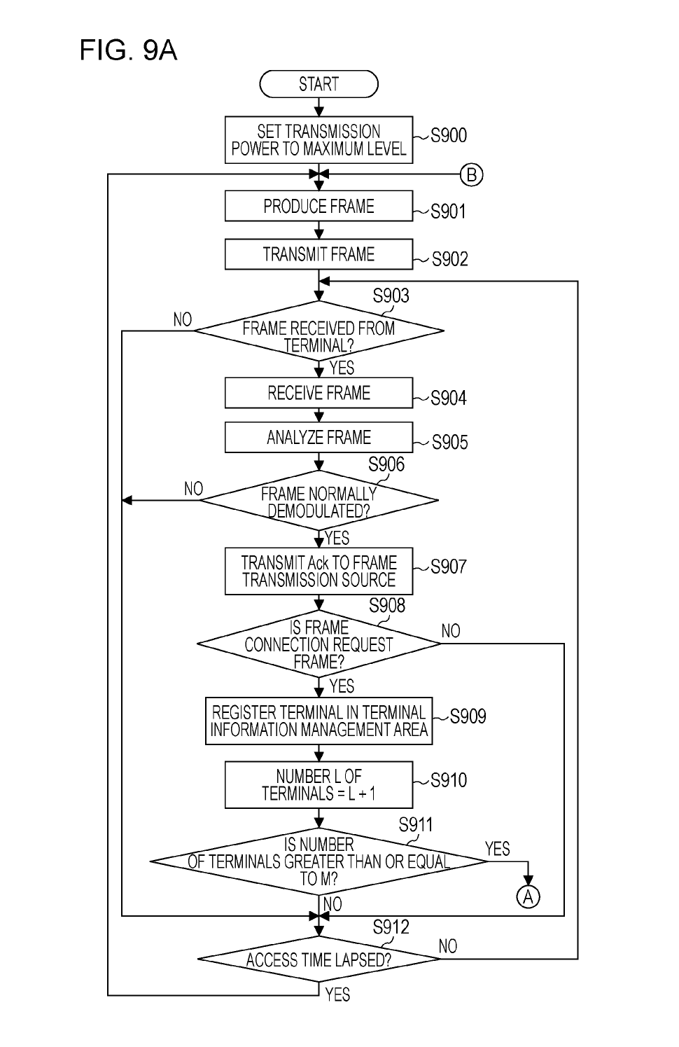

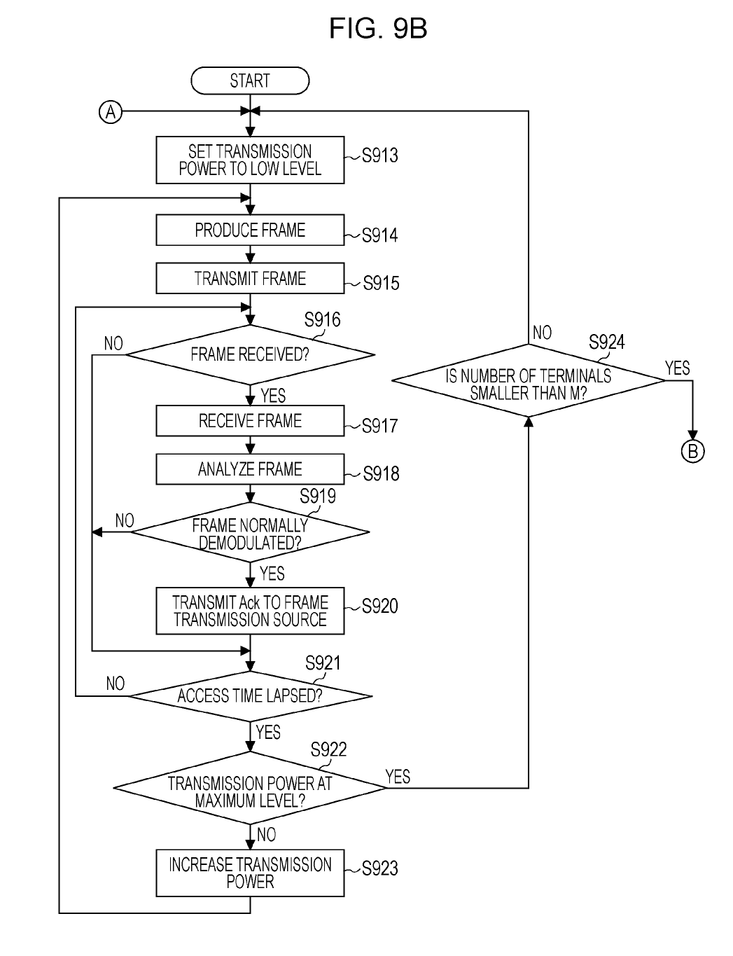

With reference to the block diagram of FIG. 1 and flowcharts of FIGS. 9A and 9B, the following description is of a transmission power control method that is effective when the control apparatus 10 is in a state capable of confirming the number of the terminals 20 belonging to the service area. The control apparatus 10 switches a control mode depending on whether the confirmed number of the terminals 20 is smaller than M or greater than or equal to M. The flowchart of FIG. 9A represents the operation when the number L of the terminals 20 registered in the terminal information management area 137 is smaller than M, and the flowchart of FIG. 9B represents the operation when the number L of the terminals 20 registered in the terminal information management area 137 is greater than or equal to M. The value M can be set prior to the start of the operation.

Turning to FIG. 9A, the CPU 110 of the control apparatus 10 issues an instruction to the transmission power adjusting unit 150 in accordance with the transmission power control program 121, thereby setting the transmission power to the maximum level (step S900). At that time, the CPU 110 stores, in the transmission power level storage area 131 of the RAM 130, the fact that the transmission power is set to the maximum level.

Then, the CPU 110 produces a broadcast frame holding the information regarding the access period in accordance with the frame production program 122, and stores the produced frame in the produced-frame storage area 132 of the RAM 130 (step S901). At that time, the CPU 110 stores, in the storage area 135 for the information regarding the access period, the information which has been designated as the information regarding the access period, e.g., the start time and the end time of the access period, and the number N of time slots (N is an arbitrary natural number) included in the access period.

In step S902, the CPU 110 transmits the broadcast frame with the transmission power at the maximum level that has been set in step S900. Thereafter, if a radio frame is sent from the terminal 20 in response to the transmitted broadcast frame, the CPU 110 receives the radio frame and stores the received frame in the received-frame storage area 133 (steps S903-S904). The CPU 110 analyzes the received radio frame and stores the analyzed frame in the analyzed-frame storage area 134 of the RAM 130 (step S905). On the other hand, if no radio frame is received in step S903, the process proceeds to step S912.

In step S906, the CPU 110 determines whether the received radio frame is normally demodulated. If the determination result indicates that the received radio frame is normally demodulated, the CPU 110 transmits, in step S907, a reception acknowledgement signal (Ack), to the terminal 20 that is a transmission source of the relevant frame. Thereafter, the process proceeds to step S908.

On the other hand, if, for example, the radio frames transmitted from the plural terminals 20 collide with each other, those frames cannot be normally demodulated and the CPU 110 determines in step S906 that the frames are not normally demodulated. Therefore, the CPU 110 does not transmit the Ack to the terminal 20 in step S907, and the process proceeds to step S908.

In step S908, the CPU 110 determines whether the received frame is the connection request frame. If the determination result indicates that the received frame is the connection request frame, the process proceeds to step S909. If the determination result indicates that the received frame is not the connection request frame, the process proceeds to step S912.

In step S909, the CPU 110 reads necessary information from the analyzed frame and registers the necessary information in the terminal information management area 137. Then, in step S910, a value of the number L of the registered terminals is incremented by one. In step S911, the CPU 110 determines whether the number L of the registered terminals 20 is greater than or equal to M. If greater than or equal to M, the process moves to step S913 (FIG. 9B). If smaller than M, flow proceeds to step S912.

In step S912, based on the information stored in the storage area 135 for the information regarding the access period, the CPU 110 determines whether the access period designated at the time of producing the broadcast frame has lapsed. If the determination result indicates that the access period is not yet lapsed, the process returns to step S903 and steps S903-S912 are repeated. If the determination result indicates that the access period has lapsed, the process returns to step S901 and steps S901-S912 are repeated.

In step S913, the CPU 110 issues an instruction to the transmission power adjusting unit 150 in accordance with the transmission power control program 121, thereby setting the transmission power to the low level. At that time, the CPU 110 stores, in the transmission power level storage area 131 of the RAM 130, the fact that the transmission power is set to the low level.

Then, as in the first embodiment, the CPU 110 produces a broadcast frame holding the information regarding the access period, stores it in the produced-frame storage area 132, and further transmits the broadcast frame with the transmission power at the maximum level which has been set in step S913 (steps S914-S915). Thereafter, if a radio frame is received from the terminal 20, the CPU 110 receives the radio frame and stores the received frame in the received-frame storage area 133. The CPU 110 analyzes the received radio frame in accordance with the frame analysis program 123 and stores the analyzed frame in the analyzed-frame storage area 134 (steps S916-S918). The CPU 110 then proceeds to step S919.

In step S919, the CPU 110 determines whether the received radio frame is normally demodulated. If the determination result indicates that the received radio frame is normally demodulated, the CPU 110 transmits, in step S920, a reception acknowledgement signal (Ack) to the terminal 20 that is a transmission source of the relevant frame.

On the other hand, if, for example, the radio frames transmitted from the plural terminals 20 collide with each other, those frames cannot be normally demodulated and the CPU 110 determines in step S919 that the frames are not normally demodulated. Therefore, the CPU 110 does not transmit the Ack to the terminal 20, and flow proceeds to step S921.

In step S921, as in the first embodiment, based on the information stored in the storage area 135 of the RAM 130 for the information regarding the access period, the CPU 110 determines whether the access period designated at the time of producing the broadcast frame has lapsed. If the determination result indicates that the access period is not yet lapsed, the process returns to step S916, and steps S916-S921 are repeated.

If the determination result indicates that the access period has lapsed, the process proceeds to step S922 in which the CPU 110 refers to the transmission power level storage area 131 and determines whether the set transmission power level is the maximum level. If the set transmission power level is not at the maximum level, the process proceeds to step S923 and increases the transmission power. When the transmission power is increased, the value of the transmission power level stored in the transmission power level storage area 131 is updated to a newly set value.

The process then returns to step S914, and steps S914-923 are repeated. Thereafter, in step S922, the CPU 110 refers to the transmission power level storage area 131 and determines whether the set transmission power level is at the maximum level. If so, the process flows to step S924.

In step S924, the CPU 110 determines whether the number L of the registered terminals 20 is smaller than M as a result of the above-mentioned process of deleting the registered terminal. If the number L of the registered terminals 20 is greater than or equal to M, the process flows to step S913 and the CPU 110 continues the operation mode of setting the transmission power level in plural stages. If the number L of the registered terminals 20 is smaller than M, the process flows to step S901.

The operation of the terminal 20 in the present embodiment is the same as that in the first embodiment. Thus, a detailed description is omitted herein.

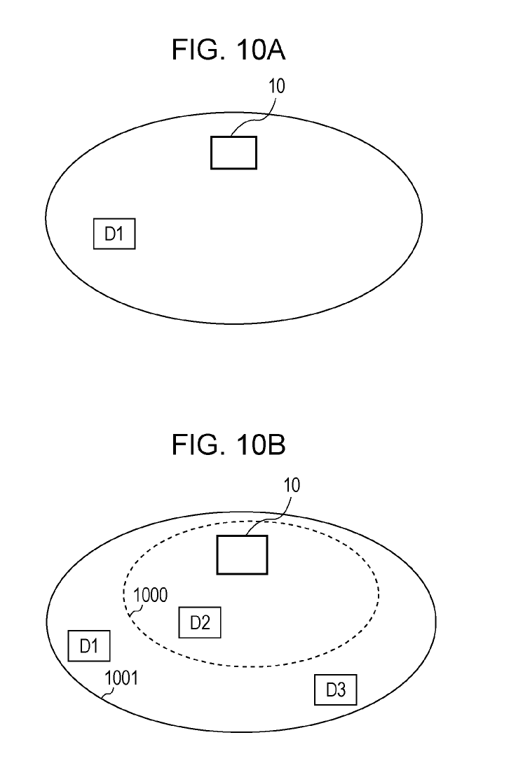

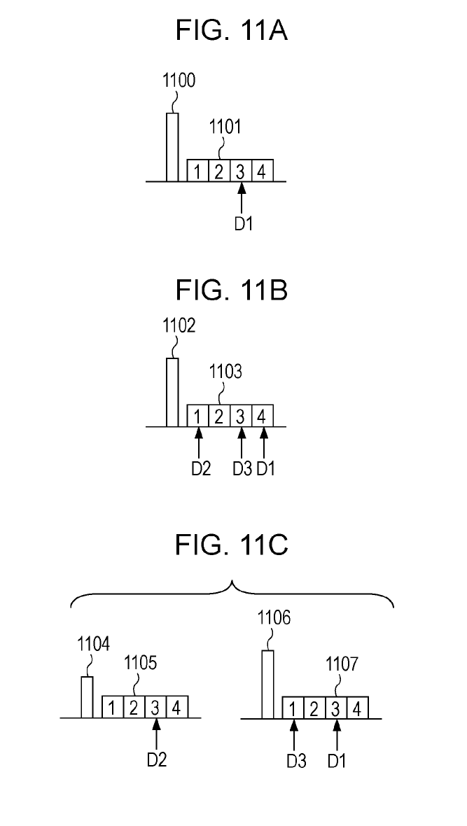

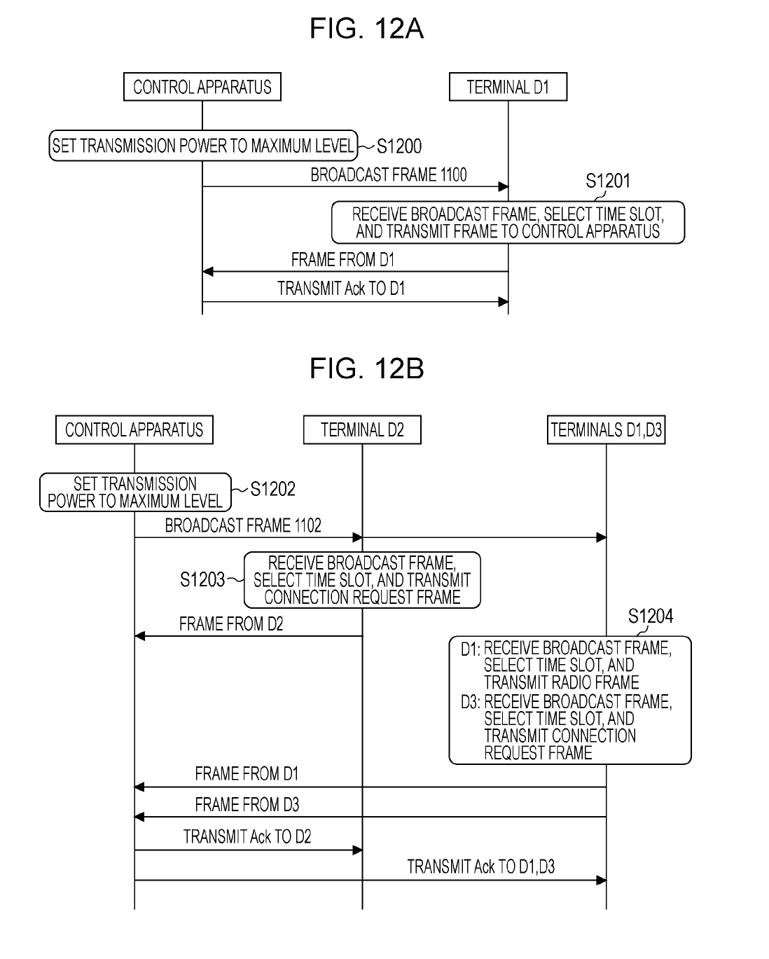

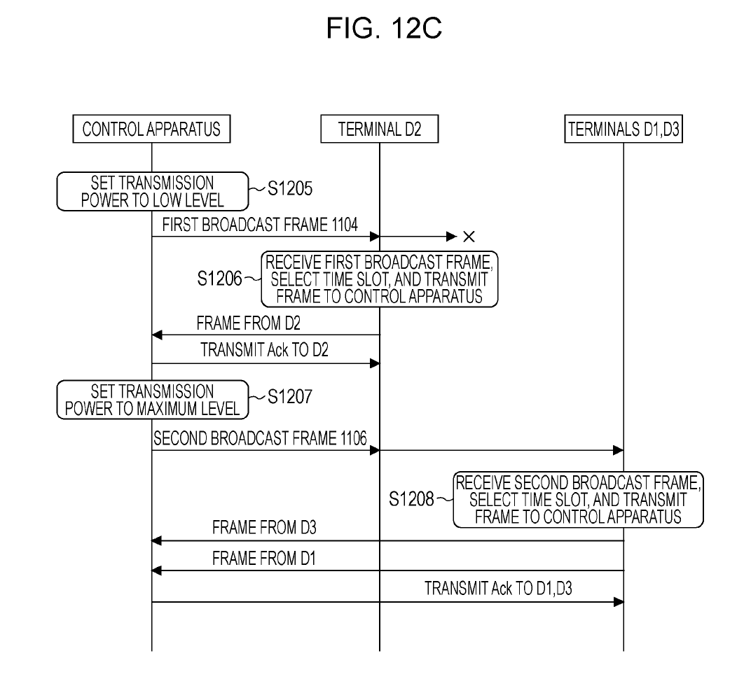

An example of the operation of the above-described radio communication system including the control apparatus 10 and the terminal 20 according to the present embodiment is described below with reference to a system illustration of FIG. 10, timing charts of FIGS. 11A-11C, and operation flowcharts of FIGS. 12A-12C. In the following description, the value of the arbitrary number M is set to 2.

In the present embodiment, it is assumed, as illustrated in FIG. 10A, that only one terminal D1 belongs to the service area of the control apparatus 10 in an initial stage. Thereafter, two terminals D2 and D3 newly participate in the service area. FIG. 10B illustrates a state of the latter case.

FIG. 11A is a chart illustrating the timing at which the terminal D1 makes an access in an access period 1101 designated by a broadcast frame 1100 that is transmitted from the control apparatus 10. FIG. 11B is a chart illustrating the timings at which the terminal D1 and the devices D2 and D3 having newly participated in the service area make accesses in an access period 1103 designated by a broadcast frame 1102. Similarly, FIG. 11C is a chart illustrating the timings at which the terminals D1, D2 and D3 make accesses in access periods 1105 and 1107 designated by a first broadcast frame 1104 and a second broadcast frame 1106 that are transmitted from the control apparatus 10.

Turning to FIG. 12A, when the radio communication system includes the control apparatus 10 and only one terminal D1 as illustrated in FIG. 10A, the control apparatus 10 first sets the transmission power to the maximum level in step S1200 upon confirming that only one terminal belongs to the radio communication system. Then, the control apparatus 10 transmits the broadcast frame 1100 with the maximum transmission power.

In step S1201, the terminal D1 receives the broadcast frame 1100, recognizes the access period 1101 based on the information regarding the access period, which is included in the broadcast frame 1100. Further, based on the information regarding time slots, the terminal D1 selects one of the time slots in which an access is to be made. Thereafter, the terminal D1 transmits a radio frame.

FIG. 11A illustrates the timing at which the terminal D1 having received the broadcast frame 1100 accesses the control apparatus 10. In the present embodiment, the terminal D1 selects, e.g., a third time slot included in the broadcast period 1101 and transmits a radio frame in the selected time slot, thereby completing the communication with the control apparatus 10. The control apparatus 10 having normally received the radio frame transmitted from the terminal D1 transmits a reception acknowledgement signal (Ack) to the terminal D1.

Then, as illustrated in FIG. 10B, the terminals D2 and D3 newly participate in the service area of the control apparatus 10. At that time, the operation of the radio communication system is described in FIG. 12B. In FIG. 12B, the control apparatus 10, which does not yet recognize the presence of the new terminals D2 and D3, transmits the broadcast frame 1102 while the transmission power remains at the maximum level in the step 1202.

Turning to FIG. 12B, the terminal D2 having received the broadcast frame 1102 transmits a connection request frame to the control apparatus 10 in step S1203. Further, the terminal D1 having received the broadcast frame 1102 transmits a radio frame to the control apparatus 10 in step S1204. However, when the certain period is not yet lapsed from the last communication and the terminal D1 is not required to respond to the broadcast frame 1102, the terminal D1 may not transmit the radio frame. In addition, in step S1204, the terminal D3 having received the broadcast frame 1102 transmits a connection request frame to the control apparatus 10.

FIG. 11B illustrates the timings at which the terminals D1, D2 and D3 each having received the broadcast frame 1102 access the control apparatus 10. In the present embodiment, the terminals D1 and D2 select, e.g., a fourth time slot and a first time slot included in the access period 1103, respectively, and transmit radio frames in the respective selected time slots. Further, the terminal D3 selects, e.g., a third time slot included in the broadcast period 1103 and transmits a radio frame in the selected time slot, thereby completing the communication with the control apparatus 10. The control apparatus 10 having normally received the radio frames transmitted from the terminals D1, D2 and D3 transmits a reception acknowledgement signal (Ack) to the terminals D1, D2 and D3.

At this point in time, the CPU 110 of the control apparatus 10 recognizes that the number of the terminals 20 within the service area is increased from one to three. This means that the number of the terminals exceeds the arbitrary number M. Therefore, the CPU 110 of the control apparatus 10 switches the control from the mode of transmitting the broadcast frame with the transmission power at the maximum level, illustrated in FIGS. 12A and 12B, to the mode illustrated in FIG. 12C.

First, in step S1205 of FIG. 12C, the CPU 110 of the control apparatus 10 in the present embodiment transmits a first broadcast frame 1104 with the transmission power at the low level. The first broadcast frame 1104 reaches up to a first broadcast frame reachable range 1000. Among the plural terminals D1-D3, the terminal located within the first broadcast frame reachable range 1000 is only D2 that is positioned relatively near the control apparatus 10, while the terminals D1 and D3 cannot receive the first broadcast frame 1104.

In step S1206, the terminal D2 receives the first broadcast frame 1104 and recognizes the access period 1105 based on the information regarding the access period, which is included in the first broadcast frame 1104. Further, based on the information regarding time slots, the terminal D2 selects one of the time slots in which an access is to be made. Thereafter, the terminal D2 transmits a radio frame.

FIG. 11C illustrates the timing at which the terminal D2 having received the first broadcast frame 1104 accesses the control apparatus 10. The terminal D2 transmits the radio frame in, e.g., a third one of the time slots included in the access period 1105, thereby completing the communication with the control apparatus 10. The control apparatus 10 having normally received the radio frame transmitted from the terminal D2 transmits a reception acknowledgement signal (Ack) to the terminal D2.

Then, in step S1207, the CPU 110 of the control apparatus 10 transmits a second broadcast frame 1106 with the transmission power at the maximum level. The second broadcast frame 1106 reaches up to a second broadcast frame reachable range 1001 shown in FIG. 10B. Therefore, all the terminals D1-D3 receive the second broadcast frame 1106. However, the terminal D2 does not respond to the second broadcast frame 1106 because it has already completed the communication. Accordingly, in step S1208, only the terminals D1 and D3 transmit radio frames to the control apparatus 10 in respective time slots included in the access period 1107.

Thus, as illustrated in FIG. 12C, the terminals D3 and D1 access the radio channel in, e.g., a first time slot and a third time slot included in the access period 1107, respectively. The radio frames transmitted from those terminals are normally received by the control apparatus 10 without causing a frame collision. The control apparatus 10 having normally received the radio frames transmitted from both the terminals D1 and D3 transmits a reception acknowledgement signal (Ack) to the terminals D1 and D3.

As described above, since the control apparatus 10 for the radio communication system according to the present embodiment confirms the number of the terminals 20 belonging to its own service area, the operation mode of the control apparatus 10 can be switched depending on the number of the terminals 20 belonging to the service area. As a result, the control apparatus 10 can perform the control in the mode suitable for the number of the terminals 20 located within the service area.

In addition, since the value of M is set to 2, the control apparatus 10 can switch the operation mode depending on whether only one terminal 20 is located within the service area or plural terminals belong to the service area. When only one terminal 20 is located within the service area, a collision between radio frames is not caused unless other one or more terminals 20 newly participate in the service area of the control apparatus 10. In such a case, there is no need of controlling the transmission power. Accordingly, the control can be efficiently performed by switching the transmission power control method depending on whether a collision is caused or a collision is not caused.

Further, when the control apparatus 10 confirms the number of the terminals belonging to its own service area as in the second exemplary embodiment, the transmission power control can also be performed by increasing the stage number of the transmission power levels depending on the number of the terminals. For example, the transmission power control is performed in two stages of the low level and the maximum level when the number of the terminals is three, while the control is modified to change the transmission power in five stages from a level 1 to a level 5 when the number of the terminals is ten.

In addition, the number of time slots included in the access period can be changed depending on the number of the terminals belonging to the service area of the control apparatus. For example, by increasing the number of time slots as the number of the terminals located within the service area increases, it is possible to reduce the probability that different terminals select the same time slot, and to suppress the generation of a frame collision.

A third exemplary embodiment of the present invention is described in connection with a case where the transmission power control method is switched by detecting a collision between frames sent from the terminals 20. The configuration of a control apparatus 10 in the present embodiment is similar to that described above in the first embodiment. Thus, a detailed description is omitted herein.

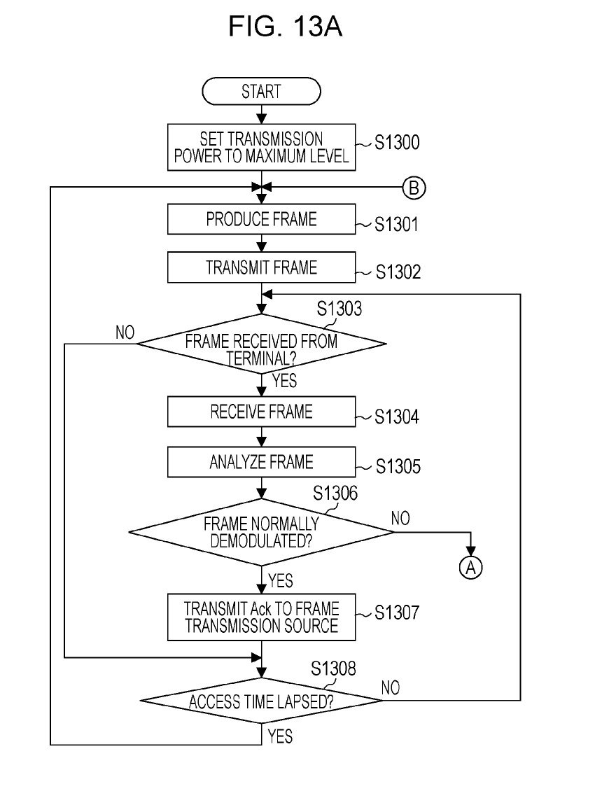

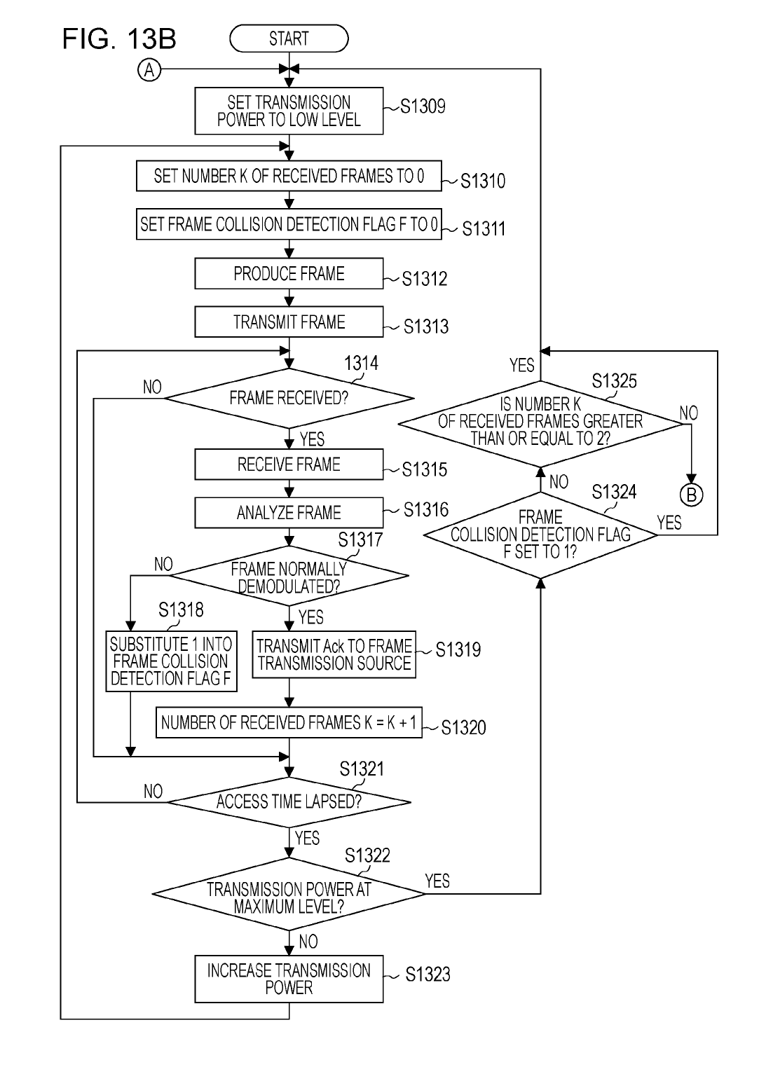

The operation of the control apparatus 10 in the present embodiment will be described with reference to the block diagram of FIG. 1 and flowcharts of FIGS. 13A and 13B. Note that, in the present embodiment, the contents of the RAM 120 in the control apparatus 10 differs slightly from those in the first exemplary embodiment.

More specifically, the RAM 130 in the present embodiment holds, in the variable storage area 136, a variable K indicating the number of frames received from the terminals 20. FIG. 13A is the flowchart representing the operation when the number of the terminals 20 located within the service area of the control apparatus 10 is one, and FIG. 13B is the flowchart representing the operation when the number of the terminals 20 located within the service area of the control apparatus 10 is greater than one.

First, the CPU 110 of the control apparatus 10 issues an instruction to the transmission power adjusting unit 150 in accordance with the transmission power control program 121, thereby setting the transmission power to the maximum level (step S1300). At that time, the CPU 110 stores, in the transmission power level storage area 131 of the RAM 130, the fact that the transmission power is set to the maximum level.

Then, the CPU 110 produces a broadcast frame holding the information regarding the access period in accordance with the frame production program 122, and stores the produced broadcast frame in the produced-frame storage area 132 of the RAM 130 (step S1301). At that time, the CPU 110 stores, in the storage area 135 for the information regarding the access period, the information which has been designated as the information regarding the access period, e.g., the start time and the end time of the access period, and the number N of time slots (N is an arbitrary natural number) included in the access period.

In step S1302, the CPU 110 transmits the broadcast frame with the transmission power at the maximum level that has been set in step S1300. Thereafter, if a radio frame is sent from the terminal 20 in response to the transmitted broadcast frame, the CPU 110 receives the radio frame and stores the received radio frame in the received-frame storage area 133 (steps S1303-S1304). The CPU 110 analyzes the received radio frame and stores the analyzed radio frame in the analyzed-frame storage area 134 of the RAM 130 (step S1305). On the other hand, if no radio frame is received in step S1303, the process proceeds to step S1308.

In step S1306, the CPU 110 determines whether the received radio frame is normally demodulated. If the determination result indicates that the received radio frame is normally demodulated, the CPU 110 transmits, in step S1307, a reception acknowledgement signal (Ack) to the terminal 20 that is a transmission source of the relevant frame. Thereafter, the process proceeds to step S1308. If, for example, the radio frames transmitted from the plural terminals 20 collide with each other, those frames cannot be normally demodulated and the CPU 110 determines in step S1306 that the frames are not normally demodulated. Therefore, the CPU 110 does not transmit the Ack and the process proceeds to step S1309 (FIG. 13B).

In step S1308, the CPU 110 determines, based on the information stored in the storage area 135 for the information regarding the access period, whether the access period having been designated at the time of producing the broadcast frame has lapsed. If the determination result indicates that the access period is not yet lapsed, the process returns to step S1303. On the other hand, if the determination result indicates that the access period has lapsed, the process returns to step S1301.

In step S1309, the CPU 110 issues an instruction to the transmission power adjusting unit 150 in accordance with the transmission power control program 121, thereby setting the transmission power to the low level. At that time, the CPU 110 stores, in the transmission power level storage area 131 of the RAM 130, the fact that the transmission power is set to the low level.

Then, in step S1310, the CPU 110 prepares the variable K, which holds the number of the frames received from the terminals 20, in the variable storage area 136 of the RAM 130 and sets the prepared variable K to an initial value 0. Further, in step S1311, the CPU 110 prepares a frame collision detection flag F in the variable storage area 136 of the RAM 130 and sets the prepared flag F to an initial value 0.

Then, the CPU 110 produces a broadcast frame holding the information regarding the access period and stores it in the produced-frame storage area 132. In step S1312-1313, the CPU 110 transmits the broadcast frame with the transmission power at the low level which has been set in step S1309. Thereafter, if a radio frame is sent from the terminal 20, the CPU 110 receives the radio frame and stores the received radio frame in the received-frame storage area 133. The CPU 110 analyzes the received radio frame in accordance with the frame analysis program 123 and stores the analyzed radio frame in the analyzed-frame storage area 134 (steps S1314-S1316).

In step S1317, the CPU 110 determines whether the received radio frame is normally demodulated. If the determination result indicates that the received radio frame is normally demodulated, the CPU 110 transmits, in step S1319, a reception acknowledgement signal (Ack) to the terminal 20 that is a transmission source of the relevant frame. If the radio frame is received from the terminal 20, the CPU 110 increments the number K of the received frames by one (step S1320).

If, for example, the radio frames transmitted from the plural terminals 20 collide with each other, those frames cannot be normally demodulated and the CPU 110 determines in step S1317 that the frames are not normally demodulated. Therefore, the CPU 110 does not transmit the Ack and the process proceeds to step S1318. In step S1318, the CPU 110 substitutes 1 into the frame collision detection flag F that has been prepared in the variable storage area 136 of the RAM 130.

In step S1321 the CPU 110 determines, based on the information stored in the storage area 135 of the RAM 130 for the information regarding the access period, whether the access period having been designated at the time of producing the broadcast frame has lapsed. If the determination result indicates that the access period is not yet lapsed, the process returns to step S1314 and steps S1314 to S1321 are repeated. If the determination result indicates that the access period has lapsed, the CPU 110 refers to the transmission power level storage area 131 and determines whether the set transmission power level is the maximum level (step S1322). If the set transmission power level is not at the maximum level, the process proceeds to step S1323 and increases the transmission power. When the transmission power is increased, the value of the transmission power level stored in the transmission power level storage area 131 is updated to a newly set value. The process then returns to step S1310 and steps S1310-S1323 are repeated. Thereafter, in step S1322, the CPU 110 refers to the transmission power level storage area 131 and determines whether the set transmission power level is at the maximum level. If so, the process proceeds to step S1324.

In step S1324, the CPU 110 determines whether the frame collision detection flag F is set to 1. The frame collision occurs when plural terminals are located within the service area. Therefore, if the frame collision detection flag F is set to 1, the CPU 110 recognizes in step S1324 that there are plural terminals within the service area of the control apparatus. Then, the process proceeds to step S1309 and continues the operation mode of setting the transmission power level in plural stages. If the frame collision detection flag F is set to 0, the process proceeds to step S1325.

If the CPU 110 determines in step S1325 that the number K of the received frames has a value greater than or equal to 2, the CPU 110 recognizes in step S1325 that the plural terminals 20 are located within the service area of the control apparatus 10. Then, the process proceeds to step S1309 and continues the operation mode of setting the transmission power level in plural stages. If the number K of the received frames has any other value, this means that there are no plural terminals 20 or there is only one terminal within the service area. The process then returns to step S1301 for switching to the operation mode of transmitting the broadcast frame with the transmission power at the maximum level.

The operation of the terminal 20 in the present embodiment is the same as that in the first embodiment, and thus a description is omitted herein.

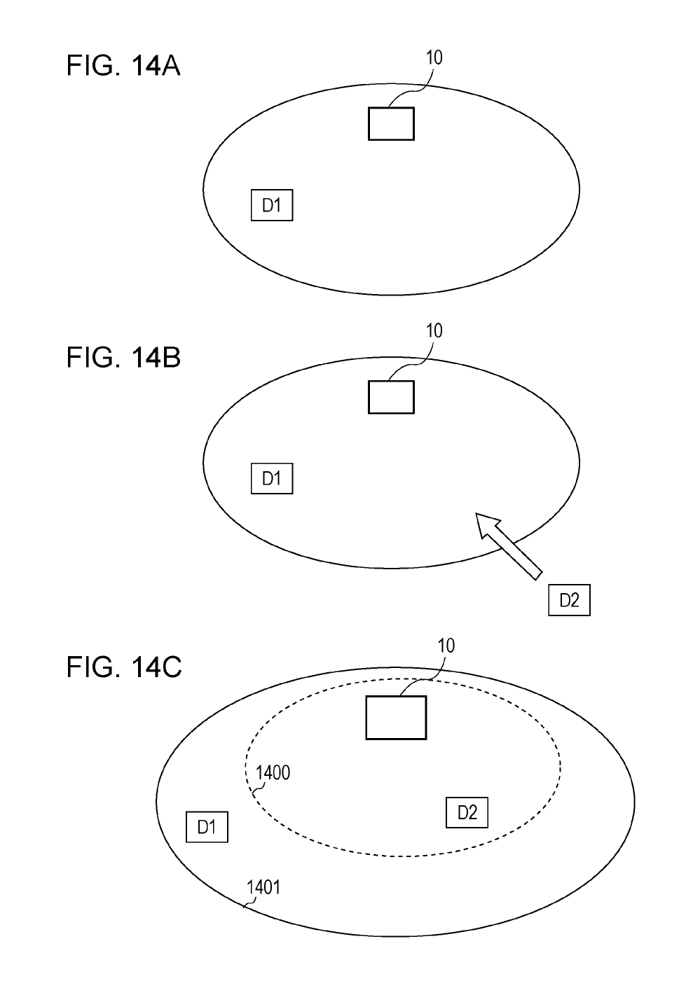

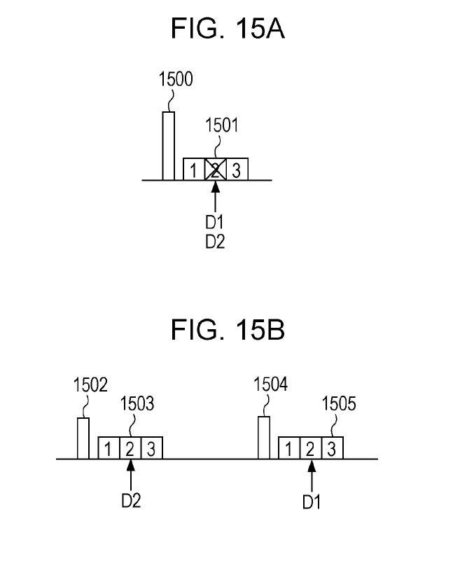

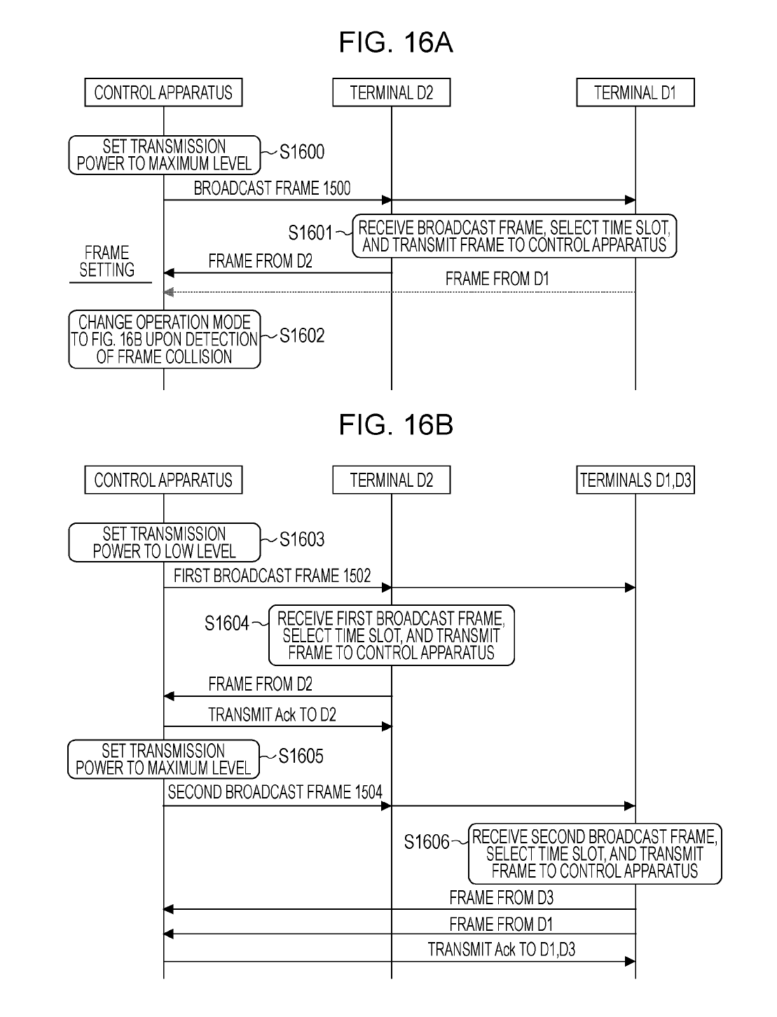

The operations of the control apparatus 10 and the terminal 20 will be described in more detail with reference to system illustrations of FIGS. 14A-14C, timing charts of FIGS. 15A and 15B, and an operation flowchart of FIG. 16.

In the present embodiment, it is assumed, as illustrated in FIG. 14A, that only one terminal D1 belongs to the service area of the control apparatus 10 in an initial stage. In such a state, the control apparatus 10 transmits a broadcast frame with the transmission power at the maximum level because only one terminal belongs to the service area. Thereafter, as illustrated in FIG. 14B, a terminal D2 newly participates in the service area of the control apparatus 10. Note that, in FIG. 14C, the range up to which the broadcast frame transmitted with the transmission power at the low level can reach is represented by a first broadcast frame reachable range 1400. In addition, the range up to which the broadcast frame transmitted with the transmission power at the maximum level can reach is represented by a second broadcast frame reachable range 1401.

In the illustrated example, the following state results with the participation of the terminal D2. As seen from FIG. 14C, the terminal D2 is located within the first broadcast frame reachable range 1400, whereas the terminal D1 is located within the second broadcast frame reachable range 1401, but it is located outside the first broadcast frame reachable range 1400.

FIGS. 15A-15B illustrate the timings at which the terminals D1 and D2 make accesses in access periods 1501, 1503 and 1505 designated by a broadcast frame 1500, a first broadcast frame 1502, and a second broadcast frame 1504 that are transmitted from the control apparatus 10.

When the radio communication system comes into the state of FIG. 14C, the control apparatus 10 does not yet recognize the presence of the new terminal D2 and transmits the broadcast frame 1500 by setting the transmission power to the maximum level in step S1600 of FIG. 16A.

In step S1601, the terminals D1 and D2 receive the broadcast frame 1500 and recognize the access period 1501 based on the information regarding the access period, which is included in the broadcast frame 1500. Further, based on the information regarding time slots, each of the terminals D1 and D2 selects one of the time slots in which an access is to be made. Thereafter, the terminals D1 and D2 transmit radio frames to the control apparatus 10 in the respective selected time slots.

FIG. 15A illustrates the timing at which each terminal having received the broadcast frame 1500 accesses the control apparatus 10. Both the terminals D1 and D2 transmit the radio frames in a second time slot within the access period 1501. Therefore, the radio frames transmitted from the two terminals collide with each other.

Because the control apparatus 10 detects signal powers of those two radio frames at the same timing, the control apparatus 10 recognizes that some radio frame is transmitted to it, but it cannot normally demodulate the two radio frames due to the collision between them. More specifically, at that time, the control apparatus 10 detects the frame collision and recognizes the presence of another new device in addition to the terminal D1 that has already been located within its own service area. Based on such recognition, the control apparatus 10 switches the operation mode to that illustrated in FIG. 16B, in step S1602 (which corresponds to the processing of a shift from step S1306 to the point A in FIGS. 13A and 13B).

After shifting to the operation mode illustrated in FIG. 16B, the control apparatus 10 starts a series of sequences for the transmission power control.

First, in step S1603, the control apparatus 10 transmits the first broadcast frame 1502 with the transmission power at the low level. The terminal D2 is located within the reachable range 1400 of the first broadcast frame 1502 and can receive the first broadcast frame 1502, while the terminal D1 is located outside the reachable range 1400 of the first broadcast frame 1502 and cannot receive the first broadcast frame 1502.

Accordingly, in step S1604, only the terminal D2 receives the first broadcast frame 1502 and recognizes the access period 1503 based on the information regarding the access period, which is included in the first broadcast frame 1502. Further, based on the information of time slots, the terminal D2 selects one of the time slots in which an access is to be made. Thereafter, the terminal D2 transmits a radio frame. As illustrated in FIG. 15B, only the terminal D2 accesses the radio channel in the second time slot within the access period 1503, and the radio frame transmitted from the terminal D2 is normally received by the control apparatus 10 without causing a frame collision. The control apparatus 10 having normally received the radio frame sent from the terminal D2 transmits a reception acknowledgement signal (Ack) to the terminal D2.

Next, in step S1605, the CPU 110 of the control apparatus 10 sets the transmission power to the maximum level and transmits the second broadcast frame 1504 with the maximum transmission power. Both the terminals D1 and D2 receive the second broadcast frame 1504. However, because D2 has already completed the communication with the control apparatus 10 in the access period 1503, only the terminal D1 transmits the radio frame to the control apparatus 10 in one of time slots included in the access period 1505 in step S1606.

In the access period 1505 illustrated in FIG. 15B, only the terminal D1 accesses the radio channel in a second time slot, and the radio frame transmitted from the terminal D1 is normally received by the control apparatus without causing a frame collision. The control apparatus 10 having normally received the radio frame sent from the terminal D1 transmits a reception acknowledgement signal (Ack) to the terminal D1.

With the control apparatus 10 for the radio communication system according to the present embodiment, as described above, even when a connection request frame is transmitted from another new terminal in addition to one or more terminals already belonging to the service area of the control apparatus 10, the operation mode can be switched by detecting a collision between frames transmitted from those terminals. As a result, the control apparatus 10 can minimize the generation of a frame collision and can succeed in communicating with all of the terminals in a shorter time.

The present embodiment has been described in connection with the case where the control apparatus 10 switches the operation mode by detecting a collision between the frames transmitted from the terminals 20. In addition, the above description has been made in connection with the case where the operation mode is switched from the mode of transmitting one broadcast frame with the transmission power at the maximum level to the mode of transmitting a plurality of broadcast frames differing in the transmission power level from each other. However, the method of switching the operation mode is not limited to the above-described ones. One exemplary modification is that the broadcast frame is transmitted while increasing the number of stages in which the transmission power is changed, by detecting a frame collision when the control apparatus 10 is operated in the mode of transmitting a plurality of broadcast frames differing in the transmission power level from each other.

The number of stages for setting the transmission power has been described as being three, i.e., a low level, a medium level, and a maximum level, in the first embodiment, and as being two, i.e., a low level and a maximum level, in the second and third embodiments. However, the number of stages for changing the transmission power can also be set to a value other than two or three. For example, the number of stages for changing the transmission power can be set to five, i.e., level 1, level 2, level 3, level 4, and level 5 (maximum level).

Further, the foregoing exemplary embodiments have been each described in connection with the case of realizing the configuration in combination of processing based on software and processing based on hardware. However, the configuration can be modified such that the processing described as being realized with software in the exemplary embodiment is realized with hardware, and the processing described as being realized with hardware in the exemplary embodiment is realized with software.

While the exemplary embodiments have been described in detail, the present invention can be implemented in various embodiments including, for example, a system, an apparatus, a method, a program, and a storage medium.

The present invention includes the case where programs of software for realizing the functions of the above-described exemplary embodiments (i.e., programs corresponding to the flowcharts shown in the drawings which have been referred to in the exemplary embodiments) are directly or remotely supplied to the system or the apparatus. In addition, the present invention includes the case where the functions of the above-described exemplary embodiments are achieved with a computer in the system or the apparatus, which reads and executes the supplied program code.

Accordingly, the program code installed in a computer, which constitutes the control apparatus or the terminal, to realize the functions and the processing of the present invention also serves to implement the present invention. Stated another way, the present invention includes computer programs for realizing the functions and the processing of the present invention.

In addition, a storage medium used to supply the computer programs includes, for example, a floppy disk, a hard disk, an optical disk, an opto-magnetic disk, an MO disk, a CD-ROM, a CD-R, a CD-RW, a magnetic tape, a nonvolatile memory card, and a ROM.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-341129 filed Dec. 19, 2006, which is hereby incorporated by reference herein in its entirety.

What is claimed is:

1. A control apparatus capable of communicating with a terminal, the control apparatus comprising:
a transmitting unit configured to transmit information designating a communication period in which the terminal transmits data to the control apparatus;
a changing unit configured to change a transmission range over which the information is transmitted; and
a control unit configured to transmit, after transmitting first information designating a first communication period over a first transmission range, second information designating a second communication period which differs from the first communication period over a second transmission range changed by the changing unit.

2. The control apparatus according to claim 1, wherein the changing unit changes the transmission range over which the information is transmitted by changing transmission power used to transmit the information.

3. The control apparatus according to claim 1, further comprising an identifying unit configured to identify any terminals located within a range communicable with the control apparatus,
wherein when there are a plurality of terminals identified, the control unit executes control to transmit, after transmitting first information designating a first communication period over a first transmission range, second information designating a second communication period that differs from the first communication period over a second transmission range changed by the changing unit.

4. The control apparatus according to claim 1, wherein the control unit executes a first process of transmitting the information over a communicable range and a second process of transmitting information, which designates different transmission periods, to a plurality of communication ranges included within the communicable range.

5. The control apparatus according to claim 4, further comprising an identifying unit configured to identify any terminals located within a range communicable with the control apparatus,
wherein the control unit executes the first process or the second process depending on how many terminals are identified.

6. The control apparatus according to claim 5, wherein the control unit executes the first process when a single terminal located within the communicable range is identified.

7. The control apparatus according to claim 5, wherein a plurality of terminals located within the range communicable with the control apparatus are identified by detecting a collision between data sent from the terminals, and
the control unit executes the second process when a plurality of terminals located within the communicable range are identified.

8. A method for a control apparatus capable of communicating with a terminal, the method comprising:
transmitting information designating a communication period in which the terminal transmits data to the control apparatus;
changing a transmission range over which the information is transmitted; and
transmitting, after transmitting first information designating a first communication period over a first transmission range, second information designating a second communication period that differs from the first communication period over a changed second transmission range.

9. The method according to claim 8, wherein the transmission range over which the information is transmitted is changed by changing transmission power used to transmit the information.

10. The method according to claim 8, further comprising:
identifying any terminals located within a range communicable with the control apparatus,
wherein when a plurality of terminals located within the range communicable with the control apparatus are identified, executing control to transmit, after transmitting first information designating a first communication period over a first transmission range, second information designating a second communication period that differs from the first communication period over a changed second transmission range.

11. The method according to claim 8, further comprising executing a first process of transmitting the information over a communicable range and a second process of transmitting information, which designates different transmission periods, to a plurality of communication ranges included within the communicable range.

12. The method according to claim 11, further comprising:
identifying any terminals located within a range communicable with the control apparatus; and
executing the first process or the second process depending on how many terminals are identified.

13. The method according to claim 12, further comprising:
executing the first process when a single terminal is identified as being located within the range communicable with the control apparatus.

14. The method according to claim 12, further comprising:
identifying that a plurality of terminals are located within the range communicable with the control apparatus by detecting a collision between data sent from the terminals located within the range communicable with the control apparatus; and
executing the second process when a plurality of terminals are located within the communicable range.

15. A communication system, the communication system comprising:
a control apparatus; and
a terminal, wherein the terminal transmits data to the control apparatus in a communication period that is designated by information transmitted from the control apparatus,
wherein the control apparatus comprises:
a changing unit configured to change a transmission range over which the information is transmitted; and
a control unit configured to transmit, after transmitting first information designating a first communication period over a first transmission range, second information designating a second communication period that differs from the first communication period over a second transmission range changed by the changing unit.

16. The communication system according to claim 15, wherein the changing unit changes the transmission range over which the information is transmitted by changing transmission power used to transmit the information.

17. The communication system according to claim 15, wherein the control apparatus further comprises an identifying unit configured to identify any terminals located within a range communicable with the control apparatus,
wherein when a plurality of terminals are identified, the control unit executes control to transmit, after transmitting first information designating a first communication period over a first transmission range, second information designating a second communication period that differs from the first communication period over a second transmission range changed by the changing unit.

18. The communication system according to claim 15, wherein the control unit executes a first process of transmitting the information over a communicable range and a second process of transmitting information, which designates different transmission periods, to a plurality of communication ranges included within the communicable range.

19. The communication system according to claim 18, wherein the control apparatus further comprises an identifying unit configured to identify any terminals located within a range communicable with the control apparatus,
wherein the control unit executes the first process or the second process depending on how many terminals are identified.

20. The communication system according to claim 19, wherein the control unit executes the first process when a single terminal located within the communicable range is identified.

21. The communication system according to claim 19, wherein a plurality of terminals located within the range communicable with the control apparatus are identified by detecting a collision between data sent from the terminals, and
wherein the control unit executes the second process when a plurality of terminals located within the communicable range are identified.

22. A computer-readable storage medium storing a program for causing a control apparatus to communicate with a terminal, the program comprising:
transmitting information designating a communication period in which the terminal transmits data to the control apparatus;
changing a transmission range over which the information is transmitted; and
transmitting, after transmitting first information designating a first communication period over a first transmission range, second information designating a second communication period that differs from the first communication period over a second transmission range.
